(19) United States
(12) Patent Application Publication
(10) Pub. No.: US 2026/0077786 A1
(43) Pub. Date: Mar. 19, 2026

(54) TRAJECTORY PLANNING SYSTEMS FOR AUTONOMOUS VEHICLES

(71) Applicant: Waymo LLC, Mountain View, CA (US)

(72) Inventors: Anar Huseynov, Sunnyvale, CA (US); Ram Vellanki, Kendall Park, NJ (US); Yue Wang, San Jose, CA (US)

(21) Appl. No.: 18/889,473

(22) Filed: Sep. 19, 2024

(51) Int. Cl. B60W 60/00; B60W 50/00

(52) U.S. Cl. CPC B60W 60/0011; B60W 50/0097; B60W 2554/4029; B60W 2554/4045; B60W 2554/4046; B60W 2554/80; B60W 2556/10

(57) ABSTRACT

Aspects of the disclosure may enable an autonomous vehicle to perform evasive maneuvers in order to avoid potential collisions. For instance, a vehicle may be controlled in an autonomous driving mode using a first trajectory generated by a first planning system. Information identifying a characteristic of a road user in an environment of the vehicle may be received and used to determine whether to generate a new behavior prediction for the road user or to use a prior determined behavior prediction. While using the first trajectory, a second planning system may be used to generate a second trajectory based on the determination. The second trajectory may be compared to the first trajectory. The vehicle may be controlled in the autonomous driving mode based on a result of the comparing.

### BACKGROUND

Autonomous vehicles for instance, vehicles that may not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, lidar, and other devices that scan, generate and/or record data about the autonomous vehicle's surroundings. This data may be combined with pre-stored map information in order to enable the autonomous vehicle to plan trajectories in order to maneuver itself through the surroundings.

### BRIEF SUMMARY

One aspect of the disclosure provides a method. The method includes controlling, by one or more processors, a vehicle in an autonomous driving mode using a first trajectory generated by a first planning system; receiving, by the one or more processors, information identifying a characteristic of a road user in an environment of the vehicle; determining, by the one or more processors, whether to generate a new behavior prediction for the road user or to use a prior determined behavior prediction based on the characteristic of the road user; while controlling the vehicle using the first trajectory, using, by the one or more processors, a second planning system to generate a second trajectory based on the determination of whether to generate a new behavior prediction for the road user or to use a prior determined behavior prediction; comparing, by the one or more processors, the second trajectory to the first trajectory; and controlling the vehicle in the autonomous driving mode based on a result of the comparing.

In one example, the method also includes using, by the one or more processors, the first planning system to generate a set of trajectories including the first trajectory and a plurality of additional trajectories. In this example, using the second planning system to generate the second trajectory involves generating a single trajectory such that there is a reduction in latency in the second planning system with respect to the first planning system. In another example, the characteristic is whether the road user has a prior behavior prediction. In another example, the characteristic is a distance between the road user and the vehicle. In another example, the characteristic is an estimated time for the road user to reach the vehicle. In another example, the characteristic is that the road user is a pedestrian. In another example, the characteristic is that the road user is a vehicle. In another example, the characteristic is a predicted behavior of the road user. In this example, the predicted behavior includes cutting in. In another example, the method also includes generating the prior determined behavior prediction using a first behavior prediction system and generating the new behavior prediction using a second behavior prediction system different from the first behavior prediction system. In this example, the second behavior prediction system is more streamlined than the first behavior prediction system such that generating new behavior prediction is faster than generating the first behavior prediction system. In another example, when the comparing indicates that the second trajectory is an improvement over the first trajectory, the controlling the vehicle based on the result includes using the second trajectory to control the vehicle. In another example, the method also includes using the first planning system to generate the first trajectory, wherein generating the first trajectory includes generating a plurality of trajectories and selecting the first trajectory from the plurality of trajectories. In this example, generating the second trajectory includes generating only the second trajectory as a single trajectory. In another example, when the comparing indicates that the second trajectory is not an improvement over the first trajectory, the controlling the vehicle based on the result includes discarding the second trajectory and using a third trajectory generated by the first planning system to control the vehicle.

Another aspect of the disclosure provides a system comprising one or more processors. The one or more processors are configured to control a vehicle in an autonomous driving mode using a first trajectory generated by a first planning system; receive information identifying a characteristic of a road user in an environment of the vehicle; determine whether to generate a new behavior prediction for the road user or to use a prior determined behavior prediction based on the characteristic of the road user; while controlling the vehicle using the first trajectory, use, a second planning system to generate a second trajectory based on the determination of whether to generate a new behavior prediction for the road user or to use a prior determined behavior prediction; compare the second trajectory to the first trajectory; and control the vehicle in the autonomous driving mode based on a result of the comparing.

In one example, the one or more processors are further configured to use the first planning system to generate a set of trajectories including the first trajectory and a plurality of additional trajectories, and to use the second planning system to generate the second trajectory by generating a single trajectory such that there is a reduction in latency in the second planning system with respect to the first planning system. In another example, the one or more processors are further configured to generate the prior determined behavior prediction using a first behavior prediction system and generate the new behavior prediction using a second behavior prediction system different from the first behavior prediction system. In another example, when the comparing indicates that the second trajectory is an improvement over the first trajectory, the one or more processors are further configured to control the vehicle based on the result by using the second trajectory to control the vehicle. In another example, when the comparing indicates that the second trajectory is not an improvement over the first trajectory, the one or more processors are further configured to control the vehicle based on the result by discarding the second trajectory and using a third trajectory generated by the first planning system to control the vehicle. In another example, the system also includes the vehicle.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example geographic area, autonomous vehicle and road users in accordance with aspects of the disclosure.

FIG. 7 is an example of behavior predictions in accordance with aspects of the disclosure.

FIG. 8 is an example of trajectories in accordance with aspects of the disclosure.

FIG. 9 is an example flow diagram in accordance with aspects of the disclosure.

### DETAILED DESCRIPTION

### Overview

The technology relates to trajectory planning systems for autonomous vehicles. Typically, autonomous vehicles may have a first planning system which generates trajectories for an autonomous vehicle in order to follow a route to a destination. In the present disclosure, in addition to this “first” planning, a “second” planning system may be used in parallel with the first planning in order to generate trajectories with reduced latency in certain situations. For instance, the second planning system may enable the autonomous vehicle to perform evasive maneuvers in order to avoid potential collisions.

In this regard, the second planning system may allow the autonomous vehicle to generate trajectories with a shorter immutable time or immutable portion. In each planning iteration, the first planning system may use information from various systems of the autonomous vehicle as well as information about a trajectory currently being used to control the autonomous vehicle in order to generate a plurality of trajectories. These may be evaluated in order to select a single trajectory for controlling the autonomous vehicle.

The second planning system may generate trajectories using the same general approach as the first planning system. However, in order to improve processing speeds, and potentially, reaction latency, the second planning system may generate fewer trajectories than the first planning system. The second planning system may be configured to achieve a reduction in latency. This may allow the autonomous vehicle to react faster than it otherwise could if relying only on trajectories from the primary planning system.

The reduction in latency may be achieved using a combination of high compute power and priority as well as other features. For instance, additional reductions in reaction latency may be achieved by deciding in real time to use the prior computed behavior prediction for an object or a new behavior prediction. The high compute (or rather, prioritized compute) may enable the planning of a trajectory by the second planning system to complete sooner than the planning of a trajectory by the first planning system, but using a new behavior prediction actually means the trajectory takes more time to complete. However, overall the second planning system may provide a faster reaction latency because the second planning system is leveraging the latest predictions based on the latest state of any road users in the autonomous vehicle's environment.

A new behavior prediction may be generated using a simplified behavior prediction system which computes predicted trajectories of objects much faster than the behavior prediction system. For instance, the simplified behavior prediction system may only be capable of processing a smaller subset of road users. Thus, the simplified behavior prediction system may trade off the accuracy and/or quality of the prediction model itself because the reduced latency can end up producing higher accuracy and/or quality overall.

Whether or not a new behavior prediction is generated may be based on one or more characteristics of an object, or more particularly a road user, detected in the autonomous vehicle's environment. The new behavior predictions and/or prior behavior predictions may be used by the second planning system to generate a second trajectory. To further save computing power and time, in some instances, the new behavior predictions and/or prior behavior predictions may also be used by the first planning system to generate a trajectory.

The second trajectory generated by the second planning system may then be evaluated against the prior trajectory generated by the first planning system. This may also be the geometry of the prior trajectory with the latest speed planning information. For example, the geometry components of the trajectories may be compared to the actual and predicted locations of other road users. If the second trajectory fairs better, the second trajectory may be used to control the autonomous vehicle. If not, the second trajectory may be discarded. The process then begins again with the first planner generating a new trajectory based on the second trajectory and so on.

In this regard, the second planning system can be run during all iterations of the planning or can be scheduled. For example, when there are road users that appear to be or are predicted to be close to the autonomous vehicle or road users that appear to be or are predicted to be cutting in. For example, a behavior prediction model may determine wither or not another roar user will overlap the autonomous vehicle's current path or geometry within some predetermined period of time, the second planner may be used to generate trajectories.

The features described above may enable an autonomous vehicle to perform evasive maneuvers in order to avoid potential collisions. By using a second planning system with reduced latency as compared to a first planning system, the autonomous vehicle to perform evasive maneuvers in order to react faster to another road user (e.g., take an evasive action) than it otherwise could if relying only on trajectories from the primary planning system to avoid potential collisions. For instance, as noted above, in the example of a system which has a 225 millisecond immutable portion, the second planning system may reduce this by 70 or even 80 milliseconds per planning iteration.

### Example Systems

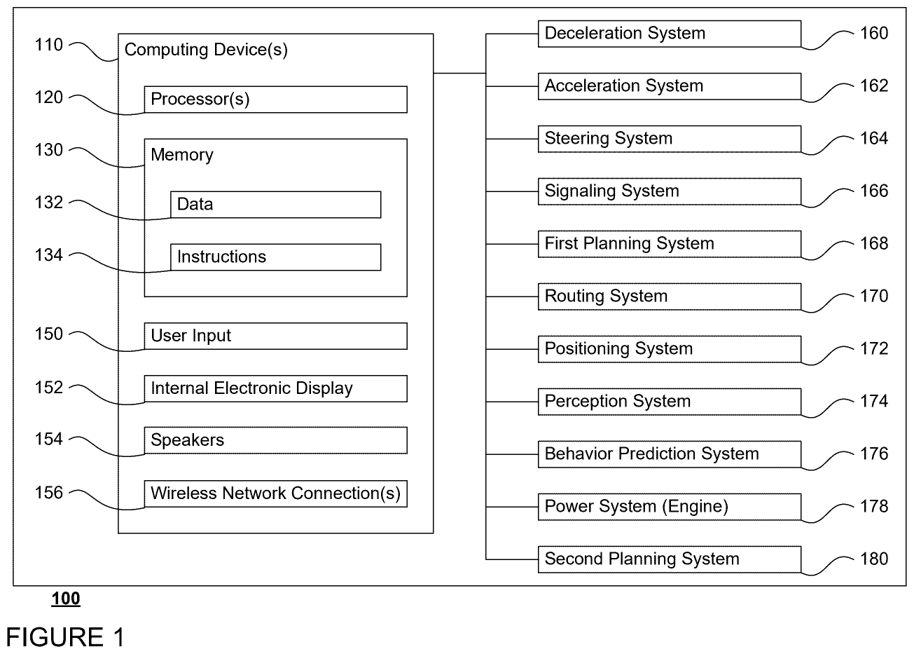

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the autonomous vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the autonomous vehicle assists with one or more driving operations (e.g., steering, braking and/or accelerating to perform lane centering, adaptive cruise control or emergency braking), the human driver is expected to be situationally aware of the autonomous vehicle's surroundings and supervise the assisted driving operations. Here, even though the autonomous vehicle may perform all driving tasks in certain situations, the human driver is expected to be responsible for taking control as needed.

In contrast, in a fully autonomous driving mode, the control system of the autonomous vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the autonomous vehicle may be any type of vehicle including, but not limited to, cars, trucks (e.g. garbage trucks, tractor-trailers, pickup trucks, etc.), motorcycles, buses, recreational vehicles, street cleaning or sweeping vehicles, etc. The autonomous vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the autonomous vehicle in order to control the autonomous vehicle in an autonomous driving mode. For example, returning to FIG. 1, computing devices 110 may be in communication with various systems of autonomous vehicle 100, such as deceleration system 160, acceleration system 162, steering system 164, signaling system 166, first planning system 168, routing system 170, positioning system 172, perception system 174, behavior prediction system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the autonomous vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the autonomous vehicle. Computing devices 110 may also use the signaling system 166 in order to signal the autonomous vehicle's intent to other drivers or vehicles, for example, by lighting turn signals or brake lights when needed.

Routing system 170 may be used by computing devices 110 in order to generate a route to a destination using map information. First planning system 168 may be used by computing device 110 in order to generate short-term trajectories that allow the autonomous vehicle to follow routes generated by the routing system. In this regard, the first planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

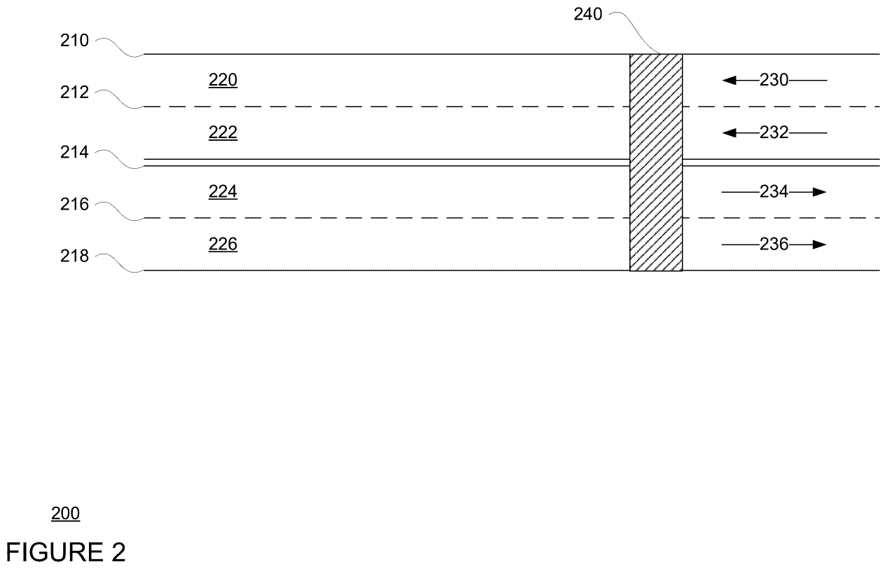

FIG. 2 is an example of map information 200 for a small section of roadway. The map information 200 that includes information identifying the shape, location, and other characteristics of lane markers or lane lines 210, 212, 214, 216, 218 which define lanes 220, 222, 224, 226. In this example, lane lines 214 represent double yellow lane lines, lane lines 212, 216 represent dashed while lane lines, and lane lines 210, 218 represent fog lines. In this example, the map information also identifies the physical area and location of a crosswalk 240.

In addition to the aforementioned features and information, the map information may also include information that identifies the direction of traffic for each lane, represented by arrows 230, 232, 234, 236. The map information may also include other information that allows the computing devices 110 to determine whether the vehicle has the right of way to complete a particular maneuver (i.e. complete a turn or cross a lane of traffic or intersection).

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the autonomous vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which edges or lanes or other mapped areas are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (in this regard, each edge in the map information may be associated with a cost to traverse that edge), types of maneuvers required, convenience to passengers or the autonomous vehicle, etc. Each route may include a list of a plurality of nodes and edges which the autonomous vehicle can use to reach the destination. Routes may be recomputed periodically as the autonomous vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the autonomous vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the autonomous vehicle. The location of the autonomous vehicle may include an absolute geographical location, such as latitude, longitude, and altitude, a location of a node or edge of the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the autonomous vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the autonomous vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the autonomous vehicle is a passenger vehicle such as a minivan or car, the autonomous vehicle may include Lidar, cameras, and/or other sensors mounted on or near the roof, fenders, bumpers or other convenient locations.

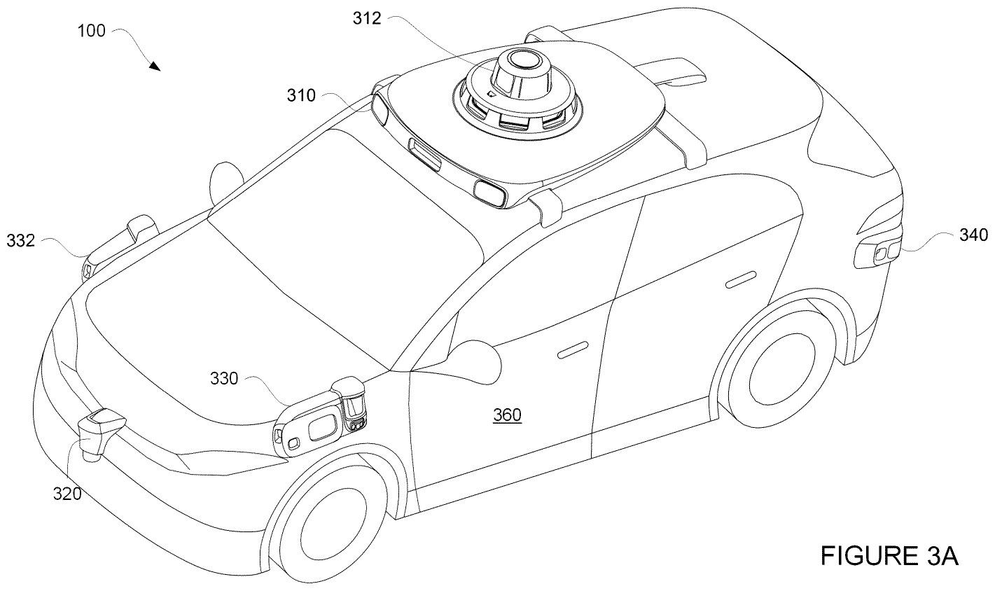

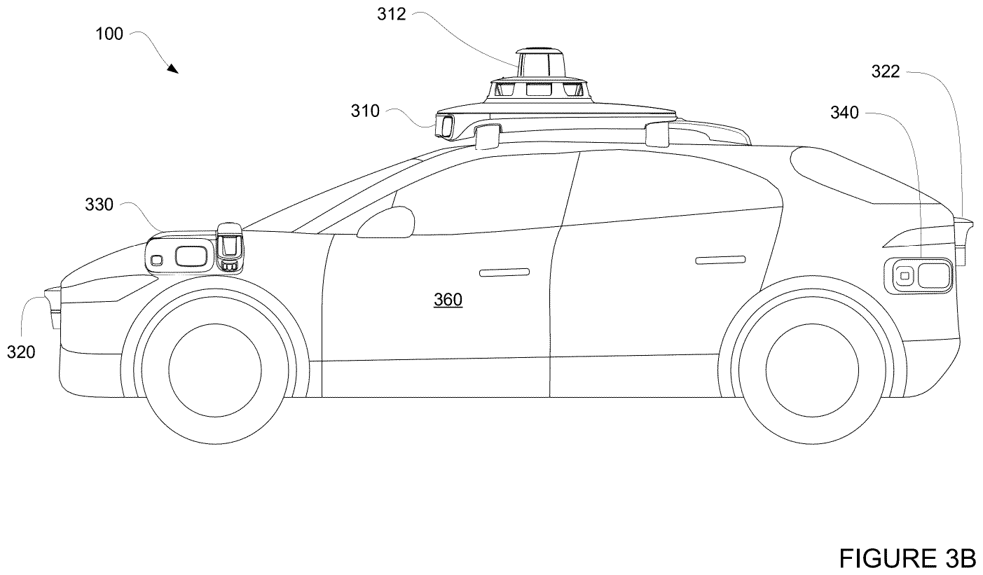

For instance, FIGS. 3A-3B are an example external views of autonomous vehicle 100. In this example, roof-top housing 310 and upper housing 312 may include a LIDAR sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the autonomous vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also arranged at the corresponding location on the passenger's side of the autonomous vehicle 100. Additional radar units and cameras (not shown) may be located at the front and rear ends of autonomous vehicle 100 and/or on other positions along the roof or roof-top housing 310.

Computing devices 110 may be capable of communicating with various components of the autonomous vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, first planning system 168, routing system 170, positioning system 172, perception system 174, behavior prediction system 176, and power system 178 (i.e. the autonomous vehicle's engine or motor) in order to control the movement, speed, etc. of autonomous vehicle 100 in accordance with the instructions 134 of memory 130.

The various systems of the autonomous vehicle may function using autonomous vehicle control software in order to determine how to control the autonomous vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior prediction system 176 which uses various behavior models based on object type to output one or more behavior predictions or predicted trajectories for a detected object to follow into the future (e.g. future behavior predictions or predicted future trajectories). In this regard, different models may be used for different types of objects, such as pedestrians, bicyclists, vehicles, etc. The behavior predictions or predicted trajectories may be a list of positions and orientations or headings (e.g. poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the autonomous vehicle as well as an emergency vehicle detection system configured to detect emergency vehicles from sensor data generated by sensors of the autonomous vehicle. Each of these detection system software modules may use various models to output a likelihood of a construction zone or an object being an emergency vehicle.

Detected objects, predicted trajectories, various likelihoods from detection system software modules, the map information identifying the autonomous vehicle's environment, position information from the positioning system 170 identifying the location and orientation of the autonomous vehicle, a destination location or node for the autonomous vehicle as well as feedback from various other systems of the autonomous vehicle may be input into a planning system software module of the first planning system 168. The first planning system 168 may use this input to generate planned trajectories for the autonomous vehicle to follow for some brief period of time into the future based on a route generated by a routing module of the routing system 170. Each planned trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the autonomous vehicle to follow the route towards reaching a destination. A control system software module of computing devices 110 may be configured to control movement of the autonomous vehicle, for instance by controlling braking, acceleration and steering of the autonomous vehicle, in order to follow a trajectory.

In addition to the first planning system 168, the autonomous vehicle 100 may include a second planning system 180. Each of the first planning system and second planning system may generated trajectories. Each trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the vehicle to follow the route towards reaching a destination location. A control system software module of computing devices 110 may be configured to control movement of the vehicle, for instance by controlling braking, acceleration and steering of the vehicle, in order to follow a trajectory.

A “planning iteration” may involve one or both the first planning systems, 168 generating a trajectory and this trajectory being published to various other systems of the autonomous vehicle. The next planning iteration may then be initiated in order to plan and publish a next trajectory and so on.

In each planning iteration, the first planning system 168 may use information from various systems of the autonomous vehicle (e.g., route, location, detected objects, behavior predictions, etc.) as well as information about a trajectory currently being used to control the autonomous vehicle in order to generate a plurality of trajectories. Each new trajectory may be generated based on updated information received from the various systems of the autonomous vehicle 100, including for example, the routing system, positioning system, perception system, and so on.

Each of the first planning system 168 and second planning system 180 may use similar process as that described above with regard to assessing costs of routes used for computing costs of and selecting a trajectory for each planning iteration. For instance, during a planning iteration, the first planning system 168 may generate a plurality of trajectories. Thereafter, the costs of each edge of a potential trajectory may be summed together with or without additional costs (e.g., additional costs for maneuvers or convenience, getting too close to other objects, etc.) in order to determine the overall cost of the potential trajectory. The lowest cost potential trajectory may then be selected by the first planning system as the next trajectory for the autonomous vehicle to follow.

The second planning system may generate trajectories using the same general approach as the first planning system. However, in order to improve speed, the second planning system may generate fewer trajectories than the first planning system in each iteration. As an example, the first planning system may generate 15 trajectories, while the second planning system may only generate a single geometry and a single speed plan for that geometry. In another example, the first planning system may generate 10 trajectories, and the second planning system may generate a single geometry and one or two speed plans. In another example, the first planning system may generate 5 trajectories, while the second planning system may generate two trajectories. Various other combinations may also be used.

The second planning system may be configured to generate a trajectory entirely within (e.g., stared and completed during) a single planning iteration of the first planning system. In some instances, the second planning system may achieve a 30% or more reduction in latency. For instance, in the example of a first planning system which has a 225 millisecond immutable portion, the second planning system may reduce this by 70 or even 80 milliseconds per planning iteration. This may allow the autonomous vehicle 100 to react faster than it otherwise could if relying only on trajectories from the primary planning system.

The reduction in latency may be achieved using a combination of high compute power and prioritized compute as well as other features. For instance, additional reductions in reaction (by the autonomous vehicle) latency may be achieved by deciding in real time to use the prior computed behavior prediction for an object or a new behavior prediction. The high compute (or rather, prioritized compute) may enable the planning of a trajectory by the second planning system to complete sooner than the planning of a trajectory by the first planning system (e.g. faster “speed”) but using a new behavior prediction actually means the trajectory takes more time to complete (e.g. lower “speed”). However, overall the second planning system may provide a faster reaction latency because the second planning system is leveraging the latest predictions based on the latest state of the road users in the autonomous vehicle's environment.

The computing devices 110 may control the autonomous vehicle in one or more of the autonomous driving modes by controlling various components. For instance, by way of example, computing devices 110 may navigate the autonomous vehicle to a destination location completely autonomously using data from the detailed map information and a trajectory from the first planning system 168 or the second planning system 180. Computing devices 110 may use the positioning system 170 to determine the autonomous vehicle's location and perception system 174 to detect and respond to objects when needed to reach the location safely. Again, in order to do so, the first planning system 168 and or second planning system 180 may generate trajectories and cause the autonomous vehicle to follow these trajectories, for instance, by causing the autonomous vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the autonomous vehicle and the wheels of the autonomous vehicle. Again, by controlling these systems, computing devices 110 may also control the drivetrain of the autonomous vehicle in order to maneuver the autonomous vehicle autonomously.

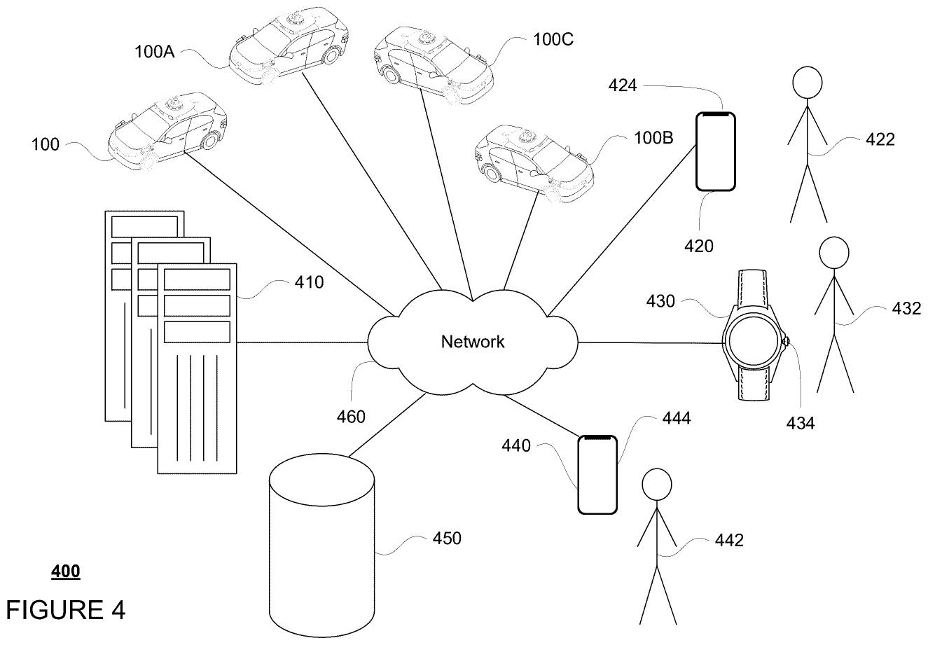

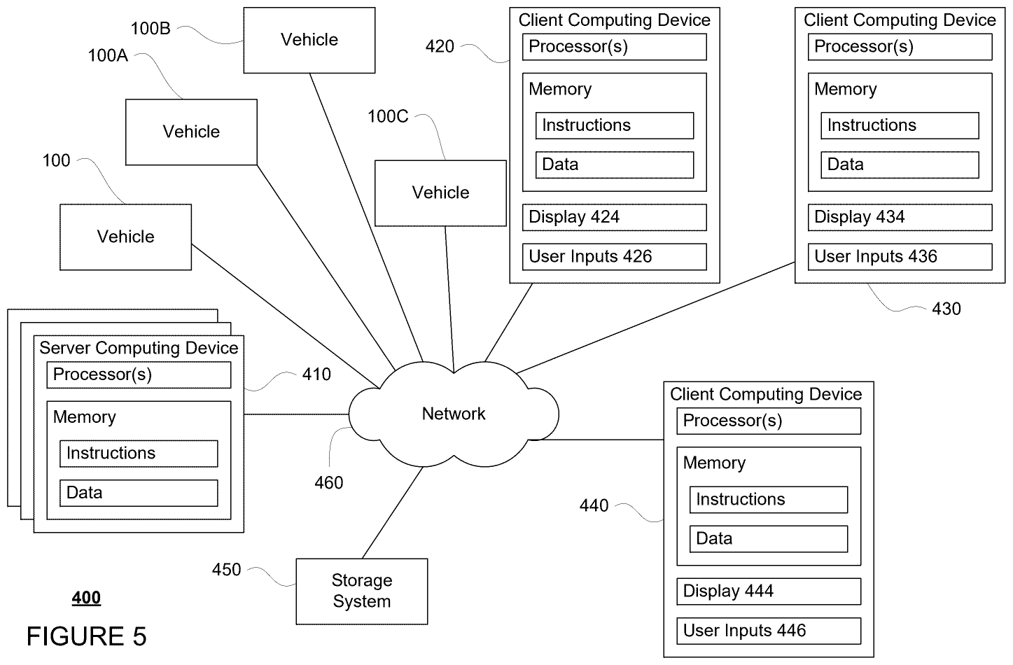

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes autonomous vehicles 100A, 100B and 100C, which may be configured the same as or similarly to autonomous vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A, 100B, 100C as well as computing devices 420, 430, 440 via the network 460. For example, autonomous vehicles 100, 100A, 100B, 100C may be a part of a fleet of vehicles that can be dispatched by server computing devices to various locations.

In this regard, the server computing devices 410 may function as a fleet management system which can be used to track the status of autonomous vehicles of the fleet and arrange trips for passengers by assigning and dispatching vehicles such as autonomous vehicles 100, 100A, 100B, 100C. These assignments may include scheduling trips to different locations in order to pick up and drop off those passengers. In this regard, the server computing devices 410 may operate using scheduling system software in order to manage the aforementioned autonomous vehicle scheduling and dispatching. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 3, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example the user may input information using a small keyboard, a keypad, microphone, using visual signals with a camera, or a touch screen. As yet another example, client computing device 440 may be a desktop computing system including a keyboard, mouse, camera and other input devices.

In some examples, client computing device 420 may be a mobile phone used by a passenger of a vehicle. In other words, user 422 may represent a passenger. In addition, client computing device 430 may represent a smart watch for a passenger of a vehicle. In other words, user 432 may represent a passenger. The client computing device 440 may represent a workstation for a human operator, for example, a human operator of a depot area, a remote assistance operator, a technician who provides roadside assistance, or someone who may otherwise provide assistance to an autonomous vehicle and/or a passenger. In other words, user 442 may represent an operator (e.g. operations person) of a transportation service utilizing the autonomous vehicles 100, 100A, 100B, 100C. Although only a few passengers and human operators are shown in FIGS. 4 and 5, any number of such passengers and human operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, etc. Storage system 450 may store various types of information which may be retrieved or otherwise accessed by a server computing devices, such as one or more server computing devices 410, in order to perform some of the features described herein.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

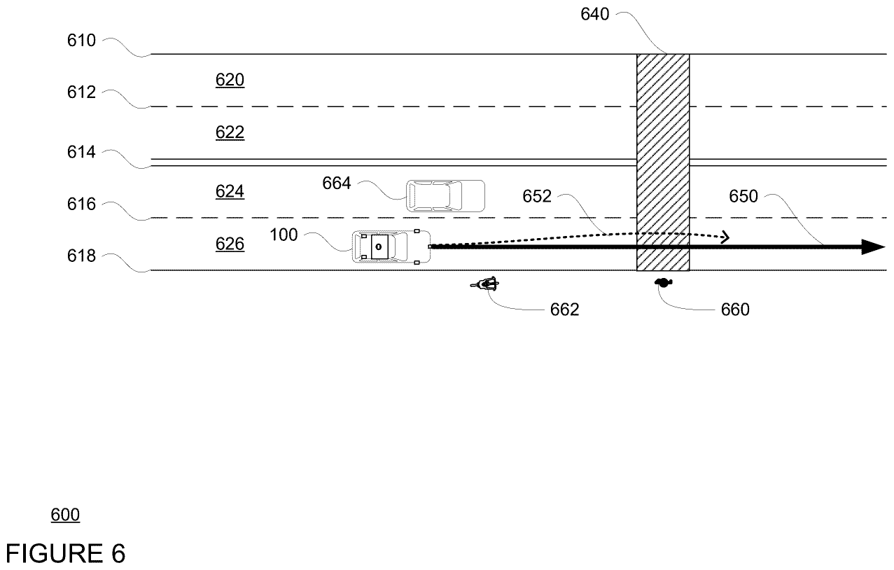

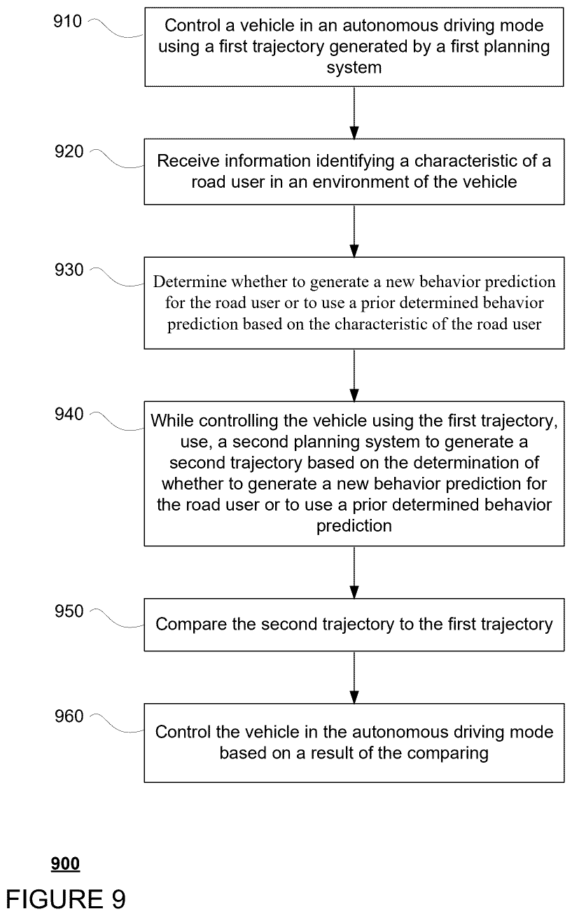

FIG. 9 is an example flow diagram 900 depicting an example of pullover location changes for autonomous vehicles, which may be performed by one or more processors, such as the one or more processors 120 of the computing devices 110 of the autonomous vehicle 100. In this example, at block 910, a vehicle is controlled in an autonomous driving mode using a first trajectory generated by a first planning system. FIG. 6 is an example of a geographic area 600 corresponding to the small section of roadway depicted in the map information 200 of FIG. 2. In this regard, the geographic area 600 includes lane lines 610, 612, 614, 616, 618 which corresponding to the shape, location, and other characteristics of lane lines 210, 212, 214, 216, 218, lanes 620, 622, 624, 626 which correspond to the shape, location, and other characteristics of lanes 220, 222, 224, 226, as well as a crosswalk 640 which correspond to the shape, location, and other characteristics of crosswalk 240. In this example, the autonomous vehicle 100 is driving in lane 620 and following a route 650 to a destination (not shown). The autonomous vehicle may be controlled by the one or more processors 120 of the computing devices 110 in the autonomous driving mode.

As noted above, the first planning system may be used to generate a trajectory for the autonomous vehicle to follow. As depicted in FIG. 6, the autonomous vehicle may be following a first trajectory 652. This first trajectory may enable the autonomous vehicle to make at least some progress towards the destination along or generally following the route. In this regard, the first trajectory, as noted above, only goes a very short period of time into the future. In some instances, such as when the autonomous vehicle is waiting for traffic or stopped at a stop sign or traffic signal light, the first trajectory may not necessarily make progress towards the destination.

Returning to FIG. 9, at block 920, information identifying a characteristics of a road user in an environment of the vehicle is received. When autonomous vehicle 100′s perception system 174 detects an object, it may also determine characteristics for that object, such as location, orientation, heading, speed, acceleration, type, etc. For example, referring to FIG. 6, the perception system 174 may detect a plurality of objects, a pedestrian 660, a bicyclist 662, and a vehicle 664 as well as their characteristics including location, orientation, heading, speed, acceleration, type (e.g., pedestrian or bicyclist or vehicle, etc.). This information may be published to the other systems of the autonomous vehicle, including the computing devices 110.

For any objects that are road users, the behavior prediction system may use the characteristics for the detected road user to make a prediction about the future characteristics of each of those road users including a predicted trajectory for each road user over time. For example, the behavior prediction system may generate behavior predictions for each of the pedestrian 660, the bicyclist 662, and the vehicle 664 based on the location, orientation, heading, speed, acceleration, types, etc. published by the perception system 174. This information as well as the behavior predictions for each of these road users may also be published to other systems of the autonomous vehicle. In this regard, the computing devices 110 may receive the characteristics for objects, including emergency vehicles, as well as a predicted trajectory for those emergency vehicles.

Returning to FIG. 9, at block 930, whether to generate a new behavior prediction for the road user or to use a prior determined behavior prediction is determined based on the characteristic of the road user. For instance, the one or more processors 120 of the computing devices 110 may determine whether or not a new behavior prediction is generated. This determination may be based on one or more characteristics of an object, or more particularly a road user, detected in the autonomous vehicle's environment. Such characteristics may be generated by and published to the other systems of the autonomous vehicle by the perception system 174.

Any number of different combinations of characteristics may be used to determine whether to generate a new behavior prediction. For instance, a new behavior prediction may be generated if the road user was newly promoted or rather, the perception system has only just determined that sensor data corresponds to an actual object to a particular level of certainty such that there is no prior behavior prediction for that object. A new behavior prediction may be generated for any potential vulnerable road user which has not yet been promoted or rather that the perception system has not yet determined that sensor data corresponds to an actual object of a particular object to the particular level of certainty. This may be especially useful where the perception system is not yet confident that it has detected an object or an object of a particular type that may be considered a vulnerable road user such as a pedestrian or bicyclist. A new behavior prediction may also be generated for road users of a certain type, such as all pedestrians and/or all bicyclists. (e.g., pedestrians, bicyclists, vehicle, etc.). A new behavior prediction may also be generated for road users within a certain distance of the autonomous vehicle (e.g., within x meters when a vehicle is traveling at x/3 meters per second or simply within x meters, wherein x is a numerical value).

A new behavior prediction may also be generated for road users with a certain time to interaction with the autonomous vehicle. A road user's time to interaction may be an amount of time the road user would take to reach the autonomous vehicle given current speed, acceleration, rate of change of acceleration, etc. of each of the autonomous vehicle and the road user. For example, this threshold amount of time may be 1 second, 2 seconds, 3 seconds or more or less. In this example, if the time to interaction for a road user is determined to be at or below this threshold, a new behavior prediction may be generated for a road user.

In some instances, a new behavior prediction may be generated for any road users exhibiting certain types of predicted behaviors (e.g., predicted to cut-in, etc.). Such predictions may be based on various techniques, such as a deep neural network that is trained based on examples of road users that overlap with an autonomous vehicle's trajectory at some point in the future (e.g., within the next 3 seconds). In this regard, for a road user having a prior behavior prediction that indicates that the road user is likely to cut-in, a new behavior prediction for that road user may be generated.

In some instances, these characteristics may be evaluated (e.g., assigned a value), scored and ranked using a machine learning model which considers a plurality of factors including time to interaction as described above. New behavior predictions may be generated for the highest scoring road users (e.g., the top N number of road users) or road users with scores greater than a threshold value.

For instance, returning to FIG. 6, a new behavior prediction may be generated for one or both of the pedestrian 660 and the bicyclist 662 given the respective types of these road users. In addition or alternatively, a new behavior prediction may be generated for the pedestrian 660 as it has been newly promoted by the perception system and does not have a prior behavior prediction. In addition or alternatively, a new behavior prediction may be generated for the pedestrian 660 as this object may have been newly promoted by the perception system. This may occur, for example, in situations in which the pedestrian 660 was previously occluded (e.g., by a larger object such as another road user, vegetation, or other structures). In addition or alternatively, a new behavior prediction may be generated for the bicyclist 662 as this object may be predicted to cut in front of the autonomous vehicle 100 in a prior behavior prediction generated by the behavior prediction system 176 in a prior planning iteration. In addition or alternatively, no new behavior predictions may be generated for any of the pedestrian 660, the bicyclist 662, or the vehicle 664. Of course, any combination of behavior predictions for different road users may be used depending on how the second planning system is configured.

For instance, the one or more processors 120 of the computing devices 110 may generate a new behavior prediction using a second or simplified behavior prediction system. This second behavior prediction system may be more streamlined and compute predicted trajectories of objects much faster than the behavior prediction system 176. For example, the second behavior prediction system may only be capable of processing a smaller subset of road users. For example, the behavior prediction system 176 may be capable of processing predictions for a large number of road users, such as 50 or more road users, in a single batch. In other implementations, an even greater number of road users could be processed, such as 100 or more or less. In this regard, additional road users may be processed in additional batches. The second behavior prediction system may only be capable of processing a single road user or a very small number of road users, such as 8 road users or more or less. Thus, the simplified behavior prediction system may trade off the accuracy and/or quality of the prediction model itself because the reduced latency can end up producing higher accuracy and/or quality overall.

Returning to FIG. 9, at block 940, while controlling the vehicle using the first trajectory, a second planning system is used to generate a second trajectory based on the determination of whether to generate a new behavior prediction for the road user or to use a prior determined behavior prediction. For instance, the one or more processors 120 of the computing devices 110 may use the new behavior predictions and/or prior behavior predictions to generate a second trajectory using the second planning system 180. To further save computing power and time, in some instances, the new behavior predictions and/or prior behavior predictions may also be used by the first planning system to generate a trajectory.

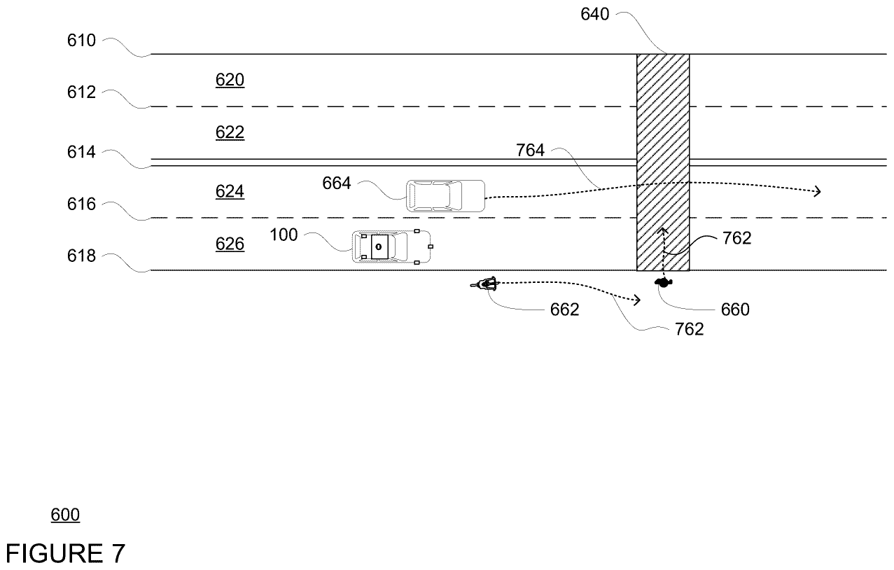

FIG. 7 depicts an example of different behavior predictions 760, 762, 764 for each of the pedestrian 660, the bicyclist 662, and the vehicle 664, respectively. In this example, each of behavior predictions 760, 762 may be a new behavior prediction generated by the simplified behavior prediction system, while behavior prediction 764 may be a prior behavior prediction generated by the behavior prediction system 176 during a prior planning iteration of the first planning system and using sensor data generated during that prior planning iteration (rather than more recently received sensor data). Of course, as noted above any combination of behavior predictions for different road users may be used depending on how the second planning system is configured.

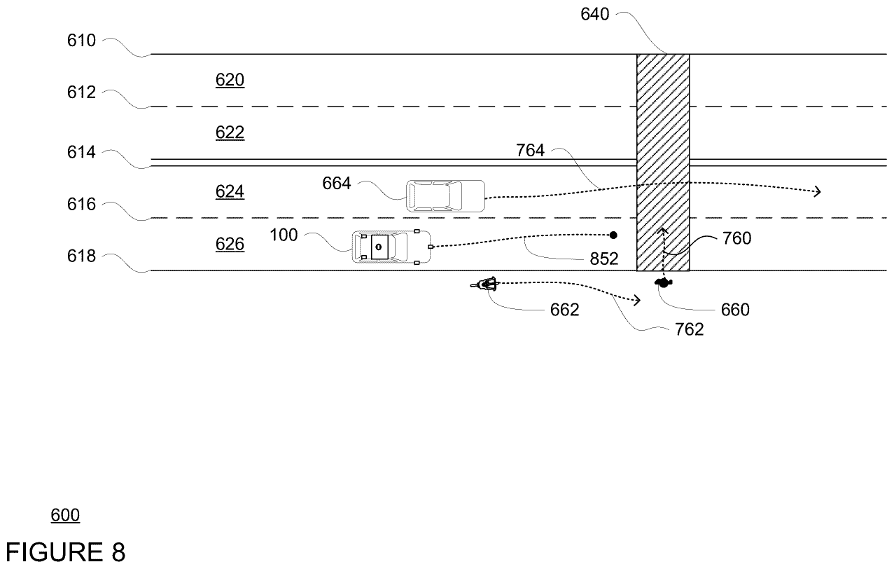

As noted above the prior and new behavior predictions may be used to generate a second trajectory using the second planning system. For example, FIG. 8 depicts an example of a second trajectory 852 which may be generated by the second planning system 180. This second trajectory 852 may result in the autonomous vehicle slightly swerving to the left within lane 620 and stopping before the autonomous vehicle reaches the crosswalk 640 and allowing the pedestrian 660 to cross in the crosswalk. Of course, this may require a had braking action from the autonomous vehicle 100 as well and may be considered an “evasive” maneuver.

Returning to FIG. 9, at block 950, the second trajectory is compared to the first trajectory. For instance, the one or more processors 120 of the computing devices 110 may compare the second trajectory generated by the second planning system may be compared to or rather, evaluated against, the prior trajectory generated by the first planning system (e.g., the current trajectory). This may also be the geometry of the prior trajectory with the latest speed planning information. For instance, a collision analysis may be performed by comparing the geometry components of the trajectories to the actual and predicted locations of other road users. This may be used to determine a likelihood of the trajectory resulting in a collision (e.g., the predicted paths of the other road users intersecting with the path of the autonomous vehicle). For example, each trajectory and the latest behavior predictions for the objects may be input into a deep neural network or other machine learning model which predicts a probability of collision (e.g., on a scale of 0 to 1, where 0 is not likely and 1 is likely). These probabilities may then be compared to one another to determine which trajectory is least likely to result in a collision. In some instances, the deep neural network or other machine learning model may also provide an estimate of the severity of any likely collision (e.g., a standardized injury severity in automotive crashes) and this may also be taken into account when comparing the trajectories). As another example, trajectories may be scored based on multiple models and factors, for example, the collision risk, the comfort, human-likeness etc. These scores may then be compared in order to select the “better trajectory.” As another example, a likelihood of collision with each road user could be determined for each of the trajectories. The likelihoods of collisions could then be compared, and in this regard, the first trajectory 652 may be compared to the second trajectory 852.

Returning to FIG. 9, at block 960, the vehicle is controlled in the autonomous driving mode based on a result of the comparing. For example, if the second trajectory is an improvement than the first trajectory (e.g., lower likelihood of collision), the second trajectory may be used by the one or more processors 120 of the computing devices 110 to control the autonomous vehicle in the autonomous driving mode as described above. In addition, even if the first planning system has not yet completed the planning iteration, the first planning system may start a new planning iteration to generate a new trajectory. In this regard, in addition to the autonomous vehicle potentially changing its behavior from the first trajectory to the second trajectory faster than waiting for the first planning system to complete a planning iteration, the first planning system may automatically begin a new planning system thereby resulting in the computing devices 110 acting upon updated sensor data from the perception system and behavior predictions from the behavior prediction sooner, and so on, thereby resulting in further reductions in latency.

If not, the second trajectory may be discarded (e.g., not used to control the autonomous vehicle). The first planner will then finish generating a new trajectory (e.g., a third trajectory) based on the second trajectory (e.g., the planning iteration ends). The third trajectory will be published to the various systems of the autonomous vehicle and begin a new planning iteration, while the third trajectory is used to control the autonomous vehicle.

In this regard, the second planning system 180 can be run during all iterations of the first planning system 168 or can be scheduled. For example, when there are road users that appear to be or are predicted to be close to the autonomous vehicle (e.g., smaller lateral or longitudinal distances in time on the order of 1.5 seconds or more or less) or road users that appear to be or are predicted to be cutting in. For example, a behavior prediction model may determine whether or not another roar user will overlap the autonomous vehicle's path (defined by the current trajectory) within some predetermined period of time (such as 3 seconds or more or less), the second planner may be used to generate trajectories.

The features described above may enable an autonomous vehicle to perform evasive maneuvers in order to avoid potential collisions. By using a second planning system with reduced latency as compared to a first planning system, the autonomous vehicle to perform evasive maneuvers in order to react faster to another road user (e.g., take an evasive action) than it otherwise could if relying only on trajectories from the primary planning system. void potential collisions. For instance, as noted above, in the example of a system which has a 225 millisecond immutable portion, the second planning system may reduce this by 70 or even 80 milliseconds per planning iteration.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method comprising:
controlling, by one or more processors, a vehicle in an autonomous driving mode using a first trajectory generated by a first planning system;
receiving, by the one or more processors, information identifying a characteristic of a road user in an environment of the vehicle;
determining, by the one or more processors, whether to generate a new behavior prediction for the road user or to use a prior determined behavior prediction based on the characteristic of the road user;
while controlling the vehicle using the first trajectory, using, by the one or more processors, a second planning system to generate a second trajectory based on the determination of whether to generate a new behavior prediction for the road user or to use a prior determined behavior prediction, wherein the second planning system is different from the first planning system;
comparing, by the one or more processors, the second trajectory to the first trajectory; and
controlling the vehicle in the autonomous driving mode based on a result of the comparing.

2. The method of claim 1, further comprising using, by the one or more processors, the first planning system to generate a set of trajectories including the first trajectory and a plurality of additional trajectories, and wherein using the second planning system to generate the second trajectory involves generating a single trajectory such that there is a reduction in latency in the second planning system with respect to the first planning system.

3. The method of claim 1, wherein the determination to generate the new behavior prediction for the road user triggers the second planning system to generate the second trajectory.

4. The method of claim 1, wherein the characteristic is a distance between the road user and the vehicle.

5. The method of claim 1, wherein the characteristic is an estimated time for the road user to reach the vehicle.

6. The method of claim 1, wherein the characteristic is that the road user is a pedestrian or a vehicle.

7. (canceled)

8. The method of claim 1, wherein the characteristic is a predicted behavior of the road user.

9. The method of claim 8, wherein the predicted behavior includes cutting in.

10. The method of claim 1, further comprising:
generating the prior determined behavior prediction using a first behavior prediction system; and
generating the new behavior prediction using a second behavior prediction system different from the first behavior prediction system.

11. The method of claim 10, wherein the second behavior prediction system is more streamlined than the first behavior prediction system such that generating new behavior prediction is faster than generating by the first behavior prediction system.

12. The method of claim 1, wherein when the comparing indicates that the second trajectory is an improvement over the first trajectory, the controlling the vehicle based on the result includes using the second trajectory to control the vehicle.

13. The method of claim 1, further comprising using the first planning system to generate the first trajectory, wherein generating the first trajectory includes generating a plurality of trajectories and selecting the first trajectory from the plurality of trajectories, and wherein generating the second trajectory includes generating only the second trajectory as a single trajectory.

14. The method of claim 1, wherein when the comparing indicates that the second trajectory is not an improvement over the first trajectory, the controlling the vehicle based on the result includes:
discarding the second trajectory; and
using a third trajectory generated by the first planning system to control the vehicle.

15. A system comprising one or more processors configured to:
control a vehicle in an autonomous driving mode using a first trajectory generated by a first planning system;
receive information identifying a characteristic of a road user in an environment of the vehicle;
determine whether to generate a new behavior prediction for the road user or to use a prior determined behavior prediction based on the characteristic of the road user;
while controlling the vehicle using the first trajectory, use a second planning system to generate a second trajectory based on the determination of whether to generate a new behavior prediction for the road user or to use a prior determined behavior prediction, wherein the second planning system is different from the first planning system;
compare the second trajectory to the first trajectory; and
control the vehicle in the autonomous driving mode based on a result of the comparing.

16. The system of claim 15, wherein the one or more processors are further configured to use the first planning system to generate a set of trajectories including the first trajectory and a plurality of additional trajectories, and to use the second planning system to generate the second trajectory by generating a single trajectory such that there is a reduction in latency in the second planning system with respect to the first planning system.

17. (canceled)

18. The system of claim 15, wherein when the comparing indicates that the second trajectory is an improvement over the first trajectory, the one or more processors are further configured to control the vehicle based on the result by using the second trajectory to control the vehicle.

19. The system of claim 15, wherein when the comparing indicates that the second trajectory is not an improvement over the first trajectory, the one or more processors are further configured to control the vehicle based on the result by:
discarding the second trajectory; and
using a third trajectory generated by the first planning system to control the vehicle.

20. The system of claim 15, further comprising the vehicle.

21. A non-transitory computer-readable medium storing instructions, which when executed by one or more processors of a vehicle, cause the vehicle to:
control the vehicle in an autonomous driving mode using a first trajectory generated by a first planning system;
receive information identifying a characteristic of a road user in an environment of the vehicle;
determine whether to generate a new behavior prediction for the road user or to use a prior determined behavior prediction based on the characteristic of the road user;
while controlling the vehicle using the first trajectory, use a second planning system to generate a second trajectory based on the determination of whether to generate a new behavior prediction for the road user or to use a prior determined behavior prediction, wherein the second planning system is different from the first planning system;
compare the second trajectory to the first trajectory; and
control the vehicle in the autonomous driving mode based on a result of the comparing.

22. The method of claim 1, wherein the second planning system is simplified and generates the second trajectory based on fewer inputs.
